(19) United States
(12) Patent Application Publication
(10) Pub. No.: US 2018/0047220 A1
(43) Pub. Date: Feb. 15, 2018

(54) DEVICE, SYSTEM AND METHOD FOR SHARING VEHICLES

(71) Applicants: Stephane SAVOURE, Quebec (CA); PVP TECHNOLOGIES CANADA INC., Quebec (CA)

(72) Inventors: Stephane SAVOURE, Quebec (CA); Serge RICARDO, Checy (FR)

(21) Appl. No.: 15/554,471

(22) PCT Filed: Mar. 4, 2016
(86) PCT No.: PCT/IB2016/051219

§ 371 Date: Aug. 30, 2017

(30) Foreign Application Priority Data
Mar. 6, 2015 (FR) 15/51897

(51) Int. Cl. G07C 5/00; G08G 1/00; G06Q 50/30; H04W 12/06; G06Q 30/06; G07C 5/08

(52) U.S. Cl. CPC G07C 5/008; G06Q 30/0645; G07C 5/08; G06Q 50/30; H04W 12/06; G08G 1/205

(57) ABSTRACT

Disclosed is a system for managing a service linked to the use, by a user, of a vehicle belonging to an owner different from the user. The system includes: a box on-board the vehicle; a unit for identifying the user; an on-board application; and remote server including: a unit for collecting sharing data, notably from the application and notably the identity of the user, a unit for collecting service data, notably from a supplier, a unit for reconciling sharing data and service data, and a unit for sharing the cost of the service between the user and the owner.

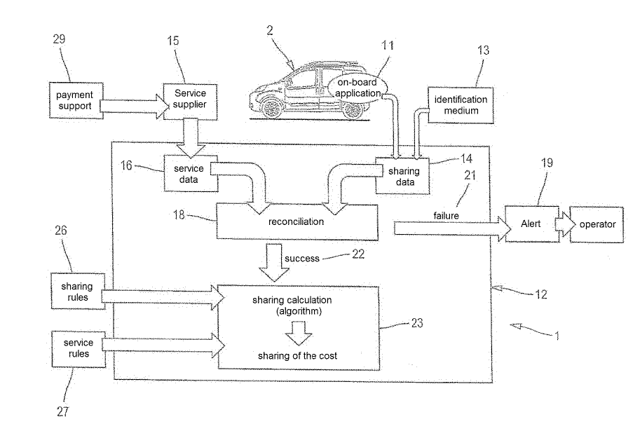

This invention relates to a system designed to provide services associated with the use of a vehicle shared between several users or a hired vehicle.

Collaborative consumption and more specifically the sharing of vehicles is intensifying and is tending to become the consumption mode of tomorrow. Yet, in light of the complexity in the financial management of a vehicle, between the costs of insurance, fuel, maintenance, depreciation, etc., the sharing thereof is still limited by the lack of methodology and technological tools that integrate these various dimensions and that share these costs simply and automatically. Particularly in the context of sharing or of hiring a vehicle between individuals, certain services are supplied with the vehicle, or are included in the hire price, others are not included. It is therefore suitable to be able to distinguish such services between them. Collaborative consumption has to be a simple consumption mode that must not harm the owner, the user, borrower or hirer.

The invention has for purpose to propose a method and a system that makes it possible to provide an exchange of collaborative services, in particular a carsharing service, without harming the owner or the user. In particular, such a system must make it possible to fairly, accurately and automatically share the costs of a car that is shared between individuals.

According to the invention, a system for managing a service linked to the use, by a user, of a vehicle belonging to an owner different from the user, is characterised in that it comprises:

means for identifying the user;

an on-board application in said vehicle;

remote server means;

said server means comprising:

means for collecting sharing data, in particular from the on-board application and in particular the identity of the user;

means for collecting service data, in particular from a supplier of said service;

means for reconciling the sharing data with the service data; and,

means for automatically sharing a cost of said service, in particular between said user and said owner.

The server means can include means for introducing sharing rules. They can also include means for introducing service rules.

The means for reconciling can be means for creating an alert if the sharing data and the service data cannot be reconciled.

Advantageously, the system according to the invention comprises a payment medium. The payment medium is more preferably allocated to the user in such a way that it can be used as an identification medium.

Alternatively, the payment medium can be allocated to the vehicle, and be available with said vehicle.

The identification medium can be directly linked to the on-board application.

Several embodiments of the invention shall be described hereinafter, by way of non-limiting examples, in reference to the annexed drawings wherein:

the single figure shows a system that implements the invention.

The figure diagrammatically shows a system 1 according to the invention, that makes it possible to implement a sharing service of a motor vehicle 2. In the example shown, the vehicle is shared by its owner, at the disposition of a user.

An on-board application 11 in the vehicle 2 is factory-fit or retro-fit, for example by the manufacturer of the vehicle, directly on the electronic and/or computer network of the vehicle, or on an on-board telematic box, or on a mobile device of the smartphone type.

A server 12, or a system of servers, remotely, manages the making available of vehicles, in particular the availability thereof, the reservation thereof or the use thereof. In what follows, the term server is used to designate a single server or a server system. The server 12 is managed by a sharing operator which the owner and the user are subscribed to. The operator provides the putting into contact between the owner and the user, for example by means of the server.

When he takes possession of the vehicle, the user logs in to the on-board application 11, by means of an identification medium 13. Such a medium can have the form of any medium that allows for identification with or without contact. This can be for example an identity card, a passport, a contactless technology card (radio, RFID, NFC) attached to the personal information of the user, an identification number supplied by a smartphone, a Bluetooth, ZigBee device, or any other radio protocol, even the smartphone or the Bluetooth device itself, of a magnetic strip card, etc. The identification device 13 can be connected directly to the on-board application 11, for example when an RFID badge reader is connected to a telematic box in the vehicle; Alternatively, the identification device 13 can be remotely connected to the on-board application 11 via the server 12, through the connexion of a smartphone, for example.

Furthermore, at any time, the on-board application transmits to the server 12 data on the sharing context 14 of the vehicle, for example:

who is using the vehicle;

where the vehicle is located;

what the sharing level of the vehicle is (reservation, use, etc.)

In the example shown of sharing a car between two individuals, one is the owner and the other the user, certain services are included in the hire price. As such, the per-kilometre hire price for the vehicle includes the corresponding fuel consumption. As such, when the user drives for a short distance, the latter generally does not need to add any fuel to the vehicle and the owner is however reimbursed proportionately for the fuel consumed. However, when the user drives for a longer distance, he may be required to add fuel in order to continue driving. If the user pays for the added fuel with his own means, with the hire price including the fuel consumption, this results:

for the portion strictly necessary for the end of the travel, in having the user pay twice for the fuel; and,

and for the portion that would be overabundant, in having the user pay for fuel that in the end would be used by the owner.

According to the invention, the system further comprises, in order resolve this difficulty:

means for collecting service data, on the context 16 of the service:
nature of the service (carburant, for example);
who pays for the service;
cost;
payment medium used;
quantity or volume;
where;
when . . .

Means for reconciling 18 the contextual sharing data and service data 14, 16 and for emitting a result 21, 22 of this reconciliation;

Means for sharing 23 service costs according to the result. Reconciliation consists in crossing the purchase data 16 and the sharing data 14 in order to check the coherency thereof. In case of an anomaly, the means of reconciliation 18 create an alert 19 which is transmitted by the system to the operator and/or to the supplier of the service 15.

The means for sharing include means 24 for collecting:

sharing rules 26, proper to the operator and generally transparent for the supplier of the service 15; and,

service rules 27, proper to the supplier of the service 15.

In the case of the fuel such as mentioned hereinabove, the sharing rules is: “the fuel is at the expense of the owner”. As such, the sharing rules are the parameters, linked to the service, that define the allocation and the expensing of the costs. For example, in a carsharing service of which the price includes the fuel, the sharing rule for a cost linked to a user who would fill up the vehicle himself, is to allocate this entire expense to the owner.

A service rule can be: “as a service supplier I want to be paid only by the operator, with the operator responsible for sharing the cost of the service between the owner and the user”. As such, the service rules are rules that are proper to the third part or service provider creating the expense. For example, in the case of the service provider who allows for the adding of fuel, or the petrol company, the latter could impose having only a single client, the operator of the carsharing service, with the operator rebilling the service thanks to means for sharing and transferring costs.

The sharing means include an algorithm that is suitable for providing the payments of services according to sharing rules 26, service rules 27, sharing data 14 and service data 16. It calculates the allocations of the costs and debits the account or accounts of the participants, for example the accounts of the owner and/or of the user.

A payment medium 29 that can be used by the user for paying for the service can consist of any medium that makes it possible to directly or indirectly carry out the payment for a purchase or a service. This is for example, a bank card, with or without contactless payment, a cheque, an electronic chip card such as fuel cards, a smartphone, a combined payment medium and identification medium card, etc. This payment medium can be individual, i.e., allocated to a given user, or shared, typically if this means of payment is allocated rather to a vehicle.

In the example mentioned hereinabove the user, other than the owner, takes a shared vehicle of which the tank is one-quarter full. At the end of the hire he returns the vehicle with the tank half full. During the hire he was therefore able to add fuel and pay for the expense with a means of payment 29 by delegation (present in the vehicle or allocated to the user, for example a subscription card to the carsharing service). In light of the nature of the expense (fuel), of the elements 14 supplied by the carsharing servers (vehicle used as carsharing at that time) and the elements 14 supplied by the on-board application in the vehicle (localisation, etc.), the fuel expense is allocated and covered by the owner of the vehicle. In this service, the user covers the fuel expense via a per-kilometre price which includes the fuel.

However, if during the use of the car, the user uses the means of payment for an external expense, which is not eligible or is not accepted by the carsharing servers, then the payment is either refused or is allocated and at the expense of the user. This expense can be food purchased in the service station at the same time as the fuel. It is therefore the same means of payment that, according to the parameters supplied by the servers and the on-board application in the vehicle, divert the payment to the account of the owner or of the user.

This same user, who, at another time, uses a second shared vehicle and carried out a fuel expense on the matter, will provoke the allocation of this expense on the account of the owner of this second vehicle. The same payment medium, according to the level of sharing and the data reconciliation algorithm, makes it possible, at a given instant, the debiting of a fuel expense on the account of the owner of the first vehicle, and at another moment, the debiting on the account of the owner of the second vehicle.

A second embodiment of the system according to the invention shall now be described, in relation with a parking service. In this example, the sharing of the vehicle integrates the making available, in the vehicle, of a shared payment medium 29.

In this example, it is supposed that the user parks the shared vehicle in a fee-paying parking space and uses the payment medium provided for this purpose in order to pay for his parking. In light of the nature of the expense 16 (parking), of the elements supplied by the carsharing servers 14 (vehicle used as carsharing at that time) and the elements supplied by the on-board application 14 in the vehicle (location, etc.), the parking expense is allocated to and is at the expense of the user, since this expense is proper to the user.

However, when the user ends his use of the vehicle, the latter is returned to its owner, who uses it and who is also confronted with the need to pay for the parking thereof. If the owner then uses the same payment medium 29, the parameters 14 supplied by the servers and the on-board application in the vehicle, divert the payment to the account of the owner.

Also, if the owner recovers his vehicle that was parked by the user in a fee-paying car park, when the owner pays for the parking at the exit, the payment can be shared between the user, for the time (reservation period of the vehicle by the user, even if he has not used it) during which the vehicle remained at the disposition of the user, and the owner for the rest of the time.

A third embodiment of the system according to the invention shall now be described, in relation with an insurance service. In this example, thanks to the authentication system 13, in any case, it is possible to adapt the insurance premium according to the user.

For example, considering that the annual premium 100% of a given vehicle is [symbol] 1000.

Thanks to the authentication system and to the information feedback coming from the on-board system, at the end of the year, it is possible to determine the following information:

Vehicle stopped: 65%

Vehicle used by Mr Dupond (coef 0.6): 10%

Vehicle used by Mrs. Dupond (coef 0.5): 10%

Shared vehicle: 15%

Thanks to this information, the insurer of the vehicle can apply the innovative rate conditions such as, for example:

Vehicle stopped: 10% reduction

Shared vehicle: cost of the insurance at the expense of the user

=>100% reduction;

Which is a final premium equal to:

(90%×65%+0.6×10%+0.5×10%+0%×15%)× [symbol] 1000= [symbol] 695

Thanks to the on-board telematic system, provided in particular with an accelerometer, and even possibly a gyrometer, it is possible to accurately determine the driving profile of each driver. In this same way, it is possible to index the economic model, and in particular the insurance model in order to apply a rule that encourages good driving (for example, −10% if you drive well).

Of course, the invention is not limited to the preferred embodiments that have just been described.

As such, the means of payment is advantageously proper to each user. It is also advantageously able to be controlled remotely by the carsharing operator in such a way that he can activate or deactivate it. Activation is preferably automatic, for example the means of payment is activated during the period of hire such as determined by the carsharing application. The means of payment can be controlled in such a way that it can only be used in certain places, and for certain products, for example only for fuel and only in France. It can also be provided to control the amount or the quantity of each expense, for example limit the purchase of fuel to fifty litres if the carsharing application estimates that the vehicle does not need more than 50 litres, for example in light of the consumption supplied by the on-board computer.

As such, the user has at his disposition a means of payment that is proper to him and that allows him to pay for the expenses that are proper to the carsharing vehicle that he is using. These expenses are controlled by the carsharing application in order to prevent fraud, application which automatically shares the expense between the owner and the user. In other words, the means of payment can advantageously be programmed and controlled remotely which allows the carsharing operator to fairly, accurately and automatically share the expenses of a carsharing vehicle.

The server means can be part of a computer management centre dedicated to the carsharing service and can in particular comprise:

a communication unit;

a management unit,

a reservation unit.

It can be comprised of a single server or of a more complex architecture, that is hosted or in the “cloud”.

The on-board application, which can be provided by the use of computers, components and functionalities that are native to the vehicle, can include in particular:

locating means (GPS type);

telecommunication means (GSM, etc.);

an accelerometer and/or gyrometer;

means for knowing the supply condition of the vehicle after contact or of any other source of information that makes it possible to identify the turning on and/or the starting up of the vehicle;

means for knowing the state of the doors . . .

A system according to the invention can be applied not only to a carsharing service, but also to a carpooling service or to a vehicle hire merchant service by a company.

A shared vehicle can have an owner or be entirely shared (multi-owners, community, association, etc.).

The invention resides particularly in the means of sharing, comprised on an on-board portion in the vehicle and a centralised portion on a computer server, which makes it possible to define a certain level of sharing of the vehicle, according to which a sharing of the costs applies according to the predefined sharing rules and service rules.

The invention allows for a payment mechanism via delegation for a carsharing vehicle: algorithms in carsharing servers, associated with an on-board application in the vehicles, make it possible to generate, remotely, the payment delegations so that an expense on the carsharing vehicle, paid with an individual or shared payment medium, is covered, partially or totally, by the owner of the vehicle, although his vehicle is used and the expense is made by a user.

Thanks to the invention it is therefore possible:

to be able to accurately and automatically measure the actual use of each user using a box installed in the vehicle or an application dedicated to carsharing installed in the on-board computer of the vehicle.

to make available to users a means of payment that makes it possible to pay in a controlled and secure manner the expenses associated with the use of the vehicle, such as the fuel, for example a card or a dedicated badge, or a dedicated payment application, for example installed on the smartphone of each user.

to implement accounting sharing algorithms that, associated with the data recorded by the vehicle, such as the location, kilometres travelled . . . , and with those linked to the means of payment, will make it possible to share expenses and to automatically debit the corresponding amounts to the user accounts.

1. System (1) for managing a service linked to the use, by a user, of a vehicle (2) belonging to an owner different from the user, comprising:
a box on-board said vehicle
means (13) for identifying the user;
an on-board application (11) in said vehicle, installed in said box;
and remote server means (12);
said server means (12) comprising:
means for collecting sharing data (14), in particular from the on-board application (11) and in particular the identity of the user;
means for collecting service data (16), in particular from a supplier (15) of said service;
means for reconciling the sharing data with the service data; and,
means (23) for automatically sharing a cost of said service, in particular between said user and said owner.

2. System according to claim 1, wherein the server means include means for introducing sharing rules (26).

3. System according to claim 1, wherein the server means include means for introducing service rules (27).

4. System according to claim 1, wherein the means for reconciling include means for creating an alert (19) if the sharing data and the service data cannot be reconciled.

5. System according to claim 1, further comprising a payment medium (29).

6. System according to claim 5, wherein the payment medium is allocated to the user and is also used as an identification medium (13).

7. System according to claim 5, wherein the payment medium is allocated to the vehicle (2), and available with said vehicle.

8. System according to claim 1, wherein the identification medium is directly connected to the on-board application.

9. System according to claim 2, wherein the server means include means for introducing service rules (27).

10. System according to claim 2, wherein the means for reconciling include means for creating an alert (19) if the sharing data and the service data cannot be reconciled.

11. System according to claim 3, wherein the means for reconciling include means for creating an alert (19) if the sharing data and the service data cannot be reconciled.

12. System according to claim 2, further comprising a payment medium (29).

13. System according to claim 3, further comprising a payment medium (29).

14. System according to claim 4, further comprising a payment medium (29).

15. System according to claim 2, wherein the identification medium is directly connected to the on-board application.

16. System according to claim 3, wherein the identification medium is directly connected to the on-board application.

17. System according to claim 4, wherein the identification medium is directly connected to the on-board application.

18. System according to claim 5, wherein the identification medium is directly connected to the on-board application.

19. System according to claim 6, wherein the identification medium is directly connected to the on-board application.

20. System according to claim 7, wherein the identification medium is directly connected to the on-board application
